(19) United States
(12) Patent Application Publication
(10) Pub. No.: US 2024/0141718 A1
(43) Pub. Date: May 2, 2024

(54) SECURITY DOOR

(71) Applicant: Jeffrey Lee Currie, Saint Petersburg, FL (US)

(72) Inventor: Jeffrey Lee Currie, Saint Petersburg, FL (US)

(21) Appl. No.: 18/495,354

(22) Filed: Oct. 26, 2023

Related U.S. Application Data
(60) Provisional application No. 63/381,041, filed on Oct. 26, 2022.

(51) Int. Cl. E06B 5/10; E05B 15/00; E06B 7/30

(52) U.S. Cl. CPC E06B 5/10; E05B 15/0093; E06B 7/30; E06B 2003/7046

(57) ABSTRACT

A security door is disclosed. The security door includes a frame, at least one bulletproof panel connected to the frame, at least one crossbar extending across the frame and connected to the at least one bulletproof panel, and at least one locking mechanism formed at least partially within the frame. The at least one locking mechanism includes at least one lift rod, at least one gravity drop lock, and at least one catch post, with the at least one lift rod supporting the at least one gravity drop lock in an unlocked position, and the at least one catch post cooperating with the at least one gravity drop lock in a locked position to lock the security door.

### CROSS-REFERENCE TO RELATED APPLICATION

This application claims the benefit of priority of U.S. provisional application No. 63/381,041, filed Oct. 26, 2022, the contents of which are herein incorporated by reference.

### BACKGROUND OF THE INVENTION

The present invention relates to door frames and, more particularly, to a door frame for bulletproof panels that work on any door.

Doors have long been used as both entryways and means for protection against outside threats. However, despite advancements in the art, modern doors are often hard to secure against outside threats and tend to include several weak spots. Many conventional doors that are designed to safeguard people within a room are complex, heavy, hard to make, require training to use, fail to meet building and fire code requirements, and/or require a power source to function. Attackers at schools, offices, and homes can and have exploited these weaknesses. Thus, conventional doors often end up being expensive props that are easily bypassed by attackers. Further, even when installed correctly and operated as designed, conventional doors designed to safeguard people are difficult to properly maintain, and thus are liable to fail when needed most.

Additionally there may be circumstances where doors may need to be opened from the outside to ensure the safety of people trapped within a room. Conventional doors do not provide a secure mechanism that prevents threats from being able to easily open the door but allows designated personnel to access a room when needed.

As can be seen, there is a need for a security door that is easy to use, easily maintained, meets building code requirements, and that eliminates the weak points found in conventional doors. The present invention solves these issues by providing a security door that is relatively lightweight, does not require a power source to operate, and is designed to be flexible so that it can be fitted to existing door frames with ease. The present invention thus provides a secure and easily operable door that protects the occupants of a room while also allowing designated personnel to access a room when needed.

### SUMMARY OF THE INVENTION

In one aspect of the present invention, a security door is provided. The security door comprises a frame, at least one bulletproof panel connected to the frame, at least one crossbar extending across the frame and connected to the at least one bulletproof panel, and at least one locking mechanism formed at least partially within the frame, wherein the at least one locking mechanism comprises at least one lift rod, at least one gravity drop lock, and at least one catch post, with the at least one lift rod supporting the at least one gravity drop lock in an unlocked position, and the at least one catch post cooperating with the at least one gravity drop lock in a locked position to lock the security door.

In another aspect of the present invention, the security door further comprises at least one peephole formed within the at least one crossbar.

In another aspect of the present invention, the security door further comprises at least one spray port formed within the at least one crossbar, the at least one spray port configured to allow fluid to be sprayed through the at least one spray port.

In another aspect of the present invention, the security door further comprises a lift rod post formed on the lift rod, and a gravity drop lock shoulder formed on the gravity drop lock, wherein the lift rod post cooperates with the gravity drop lock shoulder to support the gravity drop lock in at least the unlocked position.

In another aspect of the present invention, the security door further comprises the gravity drop lock including a gravity drop lock lip formed on a first end of the gravity drop lock, and the catch post comprising a catch post lip, with the catch post lip and gravity drop lock lip cooperating to lock the security door when the locking mechanism is in the locked position.

In another aspect of the present invention, the security door further comprises an access box adjacent the gravity drop lock, the access box comprising a channel.

In another aspect of the present invention, the security door further comprises a key port formed at a first end of the access box, wherein the key port is configured to allow a key to pass through such that the key is insertable into the channel.

In another aspect of the present invention, the security door further comprises a key slot formed within a key slot bar.

In another aspect of the present invention, the security door further comprises the key slot bar being located adjacent the access box such that the key slot is aligned with and cooperates with the channel to allow a key to enter the key slot and the channel.

In another aspect of the present invention, the security door further comprises a key cover that cooperates with the key slot such that the key slot is hidden from view.

These and other features, aspects and advantages of the present invention will become better understood with reference to the following drawings, description, and claims.

### BRIEF DESCRIPTION OF THE DRAWINGS

FIG. 1 shows a perspective view of a security door in accordance with an embodiment of the present invention;

FIG. 2 is an exploded view of a locking mechanism therefor;

FIGS. 3 and 4 are cross-sectional views of the locking mechanism taken along line 3-3 in FIG. 1 showing the locking mechanism in locked and unlocked positions;

FIG. 5 is a cross-sectional view of a crossbar of the security door taken along line 5-5 in FIG. 1.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a security door comprising a frame, a plurality of bulletproof panels connected to the frame, at least one crossbar extending across the frame and connected to at least one of the plurality of bulletproof panels, at least one spray port formed within the at least one crossbar, at least one peephole formed within the at least on crossbar, and at least one locking mechanism formed within the frame.

Further, the at least one locking mechanism comprises at least one lift rod, a gravity drop lock connected to the at least one lift rod, a catch post configured to engage the gravity drop lock such that the security door is locked, an access box adjacent the gravity drop lock, and a key slot bar, wherein the key slot bar is configured to receive a key that may then be used to lift the gravity drop lock such that the gravity drop lock disengages with the catch post and unlocks the security door.

Thus, the security door of the present invention provides a simple and easily installed device that allows bulletproof panels to be used as a door while also providing the necessary security in case of outside threats. The security door is easy to use in high-stress situations, and useful when not serving its main function. Embodiments of the present invention are flexible in configuration such that that may be easily installed in any home, school, office, and the like. Further, the present invention provides a bypass mechanism whereby designated personnel, such as emergency responders, may unlock the security door and access a room where people may need assistance.

It is noted that, as herein used, references to ‘inside’ and ‘interior’, is from the point of view of a defender inside the room that is being secured from a threat. References to ‘outside’ and ‘exterior’, are from the point of view of the threat/attacker. For example, in a school, the ‘inside’ would be the classroom where the children are protected, while the ‘outside’ is the hallway where the threat/attacker is located.

It should be noted that the material of manufacture for the present invention is not particularly limited. For example, the frame may be constructed of metals, fiber-reinforced plastics, reinforced woods, or other building materials known to be useful in creating strong and secure door frames.

It should further be noted that the method of manufacture for the present invention is not particularly limited. For example, the frame may be formed by casting, molding, machining, welding, additive manufacturing, or any other conventional method for constructing door frames and their components.

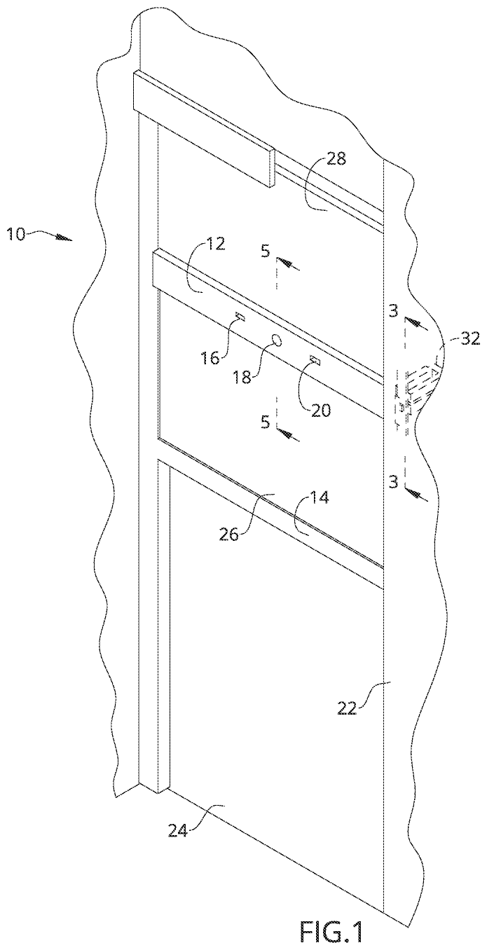

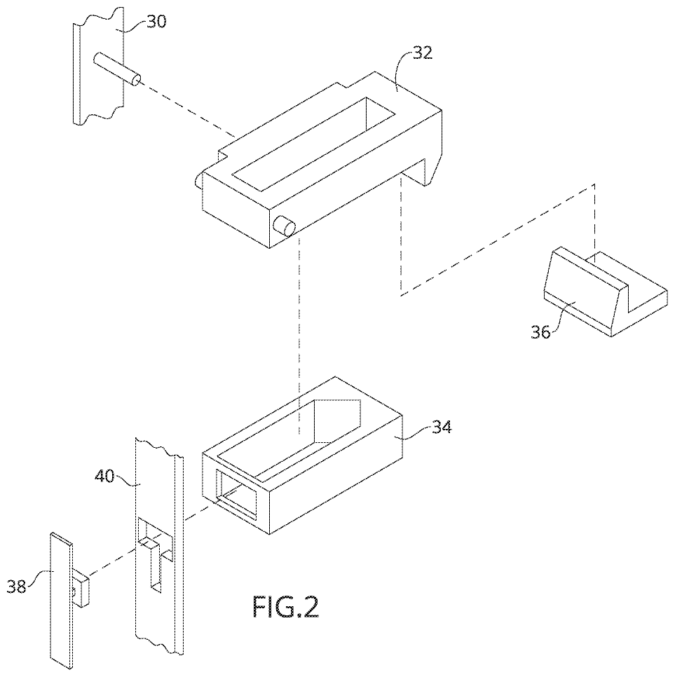

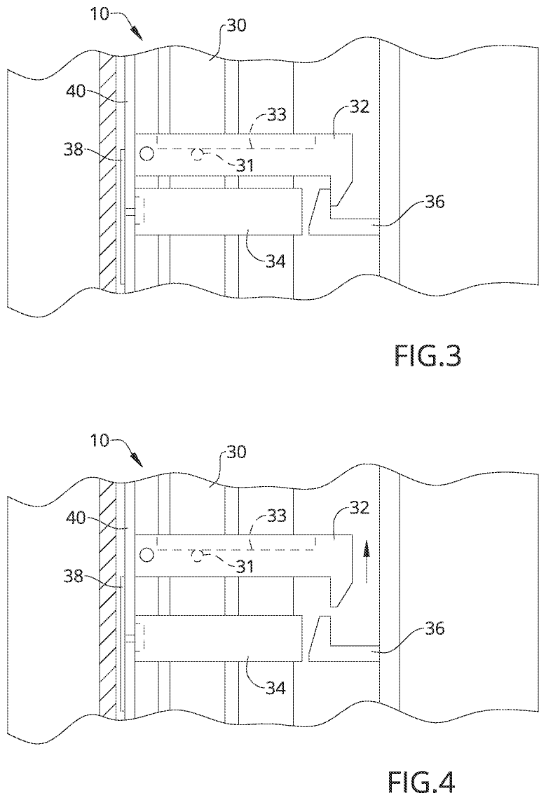

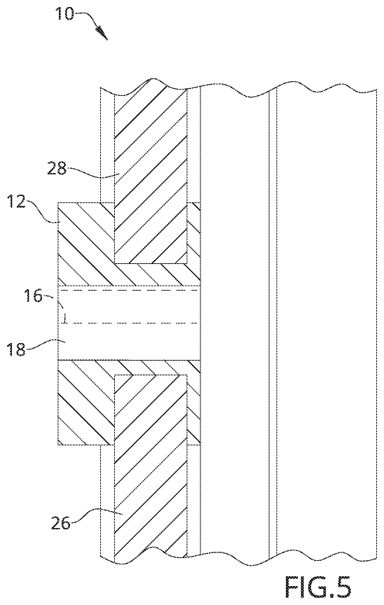

Referring now to FIGS. 1-5, a security door 10 in accordance with an embodiment of the present invention is shown. The security door 10 may comprise a plurality of bulletproof panels 24, 26, 28 securely mounted into channels within a frame 22. First and second crossbars 12, 14 may be formed to extend across the frame 22 and between adjacent bulletproof panels 24, 26, 28. A peephole 18 may be formed within the first crossbars 12 to allow defenders to view any outside attackers. In some embodiments, the peephole 18 may include a fisheye lens to provide a wider field of view to defenders. Further, the first crossbar may include at least one spray port 16, 20. Each spray port 16, 20 is configured to allow a defender to release a burst or stream of defensive spray, such as mace, pepper spray, etc., through the security door 10 and at any outside attacker. Further, a response port (not shown) may be formed within one of the first and second crossbars 12, 14, such that the response may be opened and sealed to allow a defender to counterattack any outside attackers with larger objects or weapons, such as guns, sticks, or other arms.

The security door 10 further includes at least one locking mechanism that ensures the defenders are safe inside their respective room and that any outside attacker is unable to enter the room. The locking mechanism is formed on at least one side of the security door 10, and is formed to at least partially be formed within the frame 22 of the security door 10 such that the locking mechanism locks the security door 10 to the frame 22 and any surrounding wall structure. The locking mechanism comprises at least one lift rod 30 and a gravity drop lock 32. A lift rod post 31 cooperates with a gravity lock shoulder 33 to securely connect the lift rod 30 and gravity drop lock 32 such that the lift rod 30 may lift and support the gravity drop lock 32. A catch post 36 comprising a catch bar and a catch lip is configured to engage a gravity lock lip on a first end of the gravity drop lock 32 such that the gravity drop lock 32 may be dropped into place and locked onto the catch post 36, thereby locking the security door 10.

An access box 34 is placed adjacent to and preferably below the gravity drop lock 32. The access box 34 includes a channel configured to accommodate a key or similar object such that the key or similar object may be used to lift the gravity drop lock 32 out of a locked position and into an unlocked position. The access box 34 may include a key port at a first end of the access box 34. The key port is aligned with and located adjacent to a key slot formed in a key slot bar 40. The key slot bar 40 and associated key slot are configured to receive a key that may then be inserted into the access box 34, with the key then being used to move the gravity drop lock 32 from the locked position to the unlocked position. To avoid misuse by attackers, a key cover 38 may be received and held within the key slot of the key slot bar 40 to hide the presence of the key slot. Further, in some embodiments, the security door comprises a plurality of locking mechanisms such that the security door may only be opened from the outside by the concerted effort of multiple people (e.g., multiple people must be available to open each lock mechanism and another person may then open the security door).

When installed, the security door 10 may be customized to blend into the environment and hide the fact that the security door 10 has additional security features. For example, the security door 10 may be covered in a variety of different finishes and materials, such as white board(s), magnet board(s), cork board(s), cosmetic veneers, and/or clear acrylic pocket(s), among others. Further, the security door 10 may be installed to open from either direction (e.g., into or out of a room, from a left side or a right side), and may be retrofitted to an existing doorway or into a newly constructed doorway.

In operation, the security door 10 may act as a normal door. When a defender desires to lock the security door 10 against outside attackers, the defender may cause the at least one locking mechanism to lock with a sufficiently forceful closure of the security door 10 (e.g., the defender slams the security door 10 shut). The force of the closure then causes the gravity drop lock 32 to fall into a locked position and engage with the catch post 36, preventing any attacker from opening the security door 10.

The security door 10 of the present invention is thus able to provide a safe, simple, and effective means of protecting individuals within a room from outside threats. The present invention is further able to meet fire code safety standards by providing locking mechanisms that allow designated personnel, such as emergency responders, the ability to unlock the security door 10 and access a room when necessary.

While not discussed extensively herein, it is contemplated that the security door 10 is designed such that additional security features may be embedded or attached to the security door 10 without hindering the operation of the security door 10. Such additional security features may include cameras, counterattack openings within bulletproof panels, and/or picture frames, among other features.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the preceding describes a number of separate embodiments of the apparatus and method of the present invention, what has been described herein is merely illustrative of applying the principles of the present invention. Other arrangements, methods, modifications, and substitutions by one of ordinary skill in the art are therefore also considered within the scope of the present invention, which is not to be limited except by the claims directed to the present invention.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions consistent with this specification should be adopted.

Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

It should be understood, of course, that the foregoing relates to exemplary embodiments of the invention and that modifications may be made without departing from the spirit and scope of the invention as set forth in the following claims.

What is claimed is:

1. A security door comprising:
a frame,
at least one bulletproof panel connected to the frame,
at least one crossbar extending across the frame and connected to the at least one bulletproof panel,
and at least one locking mechanism formed at least partially within the frame,
wherein the at least one locking mechanism comprises at least one lift rod, at least one gravity drop lock, and at least one catch post, with the at least one lift rod supporting the at least one gravity drop lock in an unlocked position,
and the at least one catch post cooperating with the at least one gravity drop lock in a locked position to lock the security door.

2. The security door of claim 1, further comprising at least one peephole formed within the at least one crossbar.

3. The security door of claim 1, further comprising at least one spray port formed within the at least one crossbar, the at least one spray port configured to allow fluid to be sprayed through the at least one spray port.

4. The security door of claim 1, further comprising a lift rod post formed on the lift rod, and a gravity drop lock shoulder formed on the gravity drop lock, wherein the lift rod post cooperates with the gravity drop lock shoulder to support the gravity drop lock in at least the unlocked position.

5. The security door of claim 1, wherein the gravity drop lock includes a gravity drop lock lip formed on a first end of the gravity drop lock, and the catch post comprises a catch post lip, with the catch post lip and gravity drop lock lip cooperating to lock the security door when the locking mechanism is in the locked position.

6. The security door of claim 1, further comprising an access box adjacent the gravity drop lock, the access box comprising a channel.

7. The security door of claim 6, further comprising a key port formed at a first end of the access box, wherein the key port is configured to allow a key to pass through such that the key is insertable into the channel.

8. The security door of claim 6, further comprising a key slot formed within a key slot bar.

9. The security door of claim 8, wherein the key slot bar is located adjacent the access box such that the key slot is aligned with and cooperates with the channel to allow a key to enter the key slot and the channel.

10. The security door of claim 8, further comprising a key cover that cooperates with the key slot such that the key slot is hidden from view.
